(19) United States
(12) Patent Application Publication
(10) Pub. No.: US 2012/0065912 A1
(43) Pub. Date: Mar. 15, 2012

(54) CALIBRATION DEVICE AND METHODS FOR USE WITH A LIQUID HANDLER

(76) Inventors: L. Andrew CORKAN, Glenshaw, PA (US); Daniel V. Romanelli, Turtle Creek, PA (US)

(21) Appl. No.: 12/878,239

(22) Filed: Sep. 9, 2010

(51) Int. Cl. G06F 19/00

(52) U.S. Cl. 702/94; 73/1.79

(57) ABSTRACT

In some embodiments, an apparatus includes a calibration member, an imaging device and a proximity sensor. The calibration member is configured to be removably coupled to a deck of a liquid handling system. The calibration member has an alignment portion configured to matingly engage a portion of the deck such that a position of the calibration member is fixed with respect to the deck. The imaging device is coupled to the calibration member such that an axis of a lens of the imaging device intersects the deck at a first predetermined location relative to a deck reference point in at least a first dimension and a second dimension. The proximity sensor is coupled to the calibration member such that a calibration reference point on the proximity sensor is at a second predetermined location relative to the deck reference point in a third dimension.

### BACKGROUND

The embodiments described herein relate to apparatus and methods for calibrating and/or initializing a laboratory liquid handling device, and more particularly to a calibration assembly including a proximity sensor and imaging device.

Liquid handlers are devices used to aspirate liquid from and/or dispense liquid into wells within well plates. Known liquid handlers can be used to conduct analytical research and/or clinical diagnostic testing. For example, known liquid handlers can be used to perform assays on samples disposed within the wells such as, for example, an enzyme-linked immunosorbent assay. Some known liquid handlers are automated and/or can accommodate a high volume of samples (e.g., multiple well plates each having samples in 96 or more wells). Such known liquid handlers can be used to improve the accuracy and/or speed of the transfer of liquids.

Known liquid handlers include a deck and a head that is movable with respect to the deck. Well plates having multiple sample wells (e.g., 96 sample wells) can be placed on the deck for experimentation and analysis of the liquids therein. Known heads are configured to be coupled to multiple pipettes and move the pipettes relative to the deck to facilitate transfer of liquids to and from the sample wells. Automated liquid handlers electronically control the movement of the head with respect to deck to ensure accurate and/or precise positioning of the pipette tips above the corresponding wells.

The positioning systems of known automated liquid handlers must be periodically calibrated and/or initialized to ensure that pipette tips are in the proper location relative to the deck. Such calibration ensures that the pipettes are aligned with the sample wells disposed on the deck such that the automated liquid handlers can accurately and/or precisely perform fluid transfer. Known calibration procedures include visually aligning a portion of the head with a calibration marker on the deck. Such calibration procedures often require a laboratory technician to both view the head and the marker on the deck while manually moving the head with respect to the deck using control buttons. Such a procedure is inexact, time consuming and awkward.

Thus, a need exists for improved apparatus and methods for calibrating and/or initializing laboratory liquid handling devices.

### SUMMARY

In some embodiments, an apparatus includes a calibration member, an imaging device and a proximity sensor. The calibration member is configured to be removably coupled to a deck of a liquid handling system. The calibration member has an alignment portion configured to matingly engage a portion of the deck such that a position of the calibration member is fixed with respect to the deck. The imaging device is coupled to the calibration member such that an axis of a lens of the imaging device intersects the deck at a first predetermined location relative to a deck reference point in at least a first dimension and a second dimension. The proximity sensor is coupled to the calibration member such that a calibration reference point on the proximity sensor is at a second predetermined location relative to the deck reference point in a third dimension.

### BRIEF DESCRIPTION OF THE DRAWINGS

FIG. 1 is a schematic illustration of a top view of a portion of a liquid handling system, according to an embodiment.

FIG. 2 is a schematic illustration of a side view of a portion of the liquid handling system of FIG. 1.

FIG. 3 is a front perspective view of a liquid handler, according to another embodiment.

FIG. 4 is a top view of a well plate, according to another embodiment.

FIG. 5 is a side perspective view of a portion of the head of the liquid handler of FIG. 3.

FIG. 6 shows a top view of a calibration assembly, according to an embodiment, that can be used to calibrate the liquid handler shown in FIG. 3.

FIG. 7 shows a side view of the calibration assembly of FIG. 6.

FIG. 8 is a block diagram of a control system operatively coupled to a calibration assembly of FIG. 6 and the liquid handler of FIG. 3.

FIG. 9 is a screen shot of a control interface of a display, according to another embodiment.

FIG. 10 is a screen shot of an X/Y calibration interface of a display, according to another embodiment.

FIG. 11 is a schematic illustration of a side perspective view of a calibration assembly, according to another embodiment.

FIG. 12 is a flow chart illustrating a method of calibrating a liquid handling system, according to another embodiment.

FIGS. 13 and 14 are schematic illustrations of side views of portions of liquid handling systems, according to other embodiments.

### DETAILED DESCRIPTION

Apparatus and methods for calibrating and/or initializing a laboratory liquid handling device are described herein. In some embodiments, an apparatus includes a calibration member, an imaging device and a proximity sensor. The calibration member is configured to be removably coupled to a deck of a liquid handling system. The calibration member has an alignment portion configured to matingly engage a portion of the deck such that a position of the calibration member is fixed with respect to the deck. The imaging device is coupled to the calibration member such that an axis of a lens of the imaging device intersects the deck at a first predetermined location relative to a deck reference point in at least a first dimension and a second dimension. The proximity sensor is coupled to the calibration member such that a calibration reference point on the proximity sensor is at a second predetermined location relative to the deck reference point in a third dimension.

The calibration member can be used to calibrate, initialize and/or zero a head of the liquid handling system with respect to the deck of the liquid handling system. For example, the head can be positioned above and/or aligned vertically with the lens such that the lens can produce an image of the head. This image can be used to calibrate, initialize and/or zero the head in the first dimension and the second dimension. Similarly, the head can be lowered and/or brought closer to the proximity sensor. When the head touches and/or comes in close proximity to the proximity sensor, the system can initialize the head in the third dimension. Because the axis of the lens intersects the first predetermined location and the calibration reference point of the proximity sensor is disposed at the second predetermined location each time the calibration member is recoupled to the deck, the calibration member can be used to accurately calibrate, initialize and/or zero the head.

In some embodiments, a system includes a calibration assembly and a control system. The calibration assembly is configured to be removably coupled to a deck of a liquid handling system such that an alignment portion of the calibration assembly matingly engages a portion of the deck of the liquid handling system. The calibration assembly includes an imaging device and a proximity sensor. The imaging device is configured to produce a first electronic output associated with a first position of a portion of a head of the liquid handling system relative to the deck in a first dimension and a second dimension. The proximity sensor is configured to produce a second electronic output associated with a second position of the portion of the head relative to the deck in a third dimension. The control system is configured to produce a calibration parameter based, at least in part, on the first electronic output and the second electronic output. In some embodiments, the control system is configured to move the portion of the head relative to the deck in the first dimension, the second dimension and the third dimension to at least a third predetermined position based, at least in part, on the calibration parameter.

The term “parallel” is used herein to describe a relationship between two geometric constructions (e.g., two lines, two planes, a line and a plane, two curved surfaces, a line and a curved surface or the like) in which the two geometric constructions are substantially non-intersecting as they extend substantially to infinity. For example, as used herein, a planar surface (i.e., a two-dimensional surface) is said to be parallel to a line when every point along the line is spaced apart from the nearest portion of the planar surface by a substantially equal distance. Similarly, a line is said to be parallel to a curved surface when the line and the curved surface do not intersect as they extend to infinity and when every point along the line is spaced apart from the nearest portion of the curved surface by a substantially equal distance. Two geometric constructions are described herein as being “parallel” or “substantially parallel” to each other when they are nominally parallel to each other, such as for example, when they are parallel to each other within a tolerance. Such tolerances can include, for example, manufacturing tolerances, measurement tolerances or the like.

The terms “perpendicular,” “orthogonal,” and/or “normal” are used herein to describe a relationship between two geometric constructions (e.g., two lines, two planes, a line and a plane, two curved surfaces, a line and a curved surface or the like) in which the two geometric constructions intersect at an angle of approximately 90 degrees within at least one plane. For example, as used herein, a line is said to be normal to a curved surface when the line and a portion of the curved surface intersect at an angle of approximately 90 degrees within a plane. Two geometric constructions are described herein as being, for example, “perpendicular” or “substantially perpendicular” to each other when they are nominally perpendicular to each other, such as for example, when they are perpendicular to each other within a tolerance. Such tolerances can include, for example, manufacturing tolerances, measurement tolerances or the like.

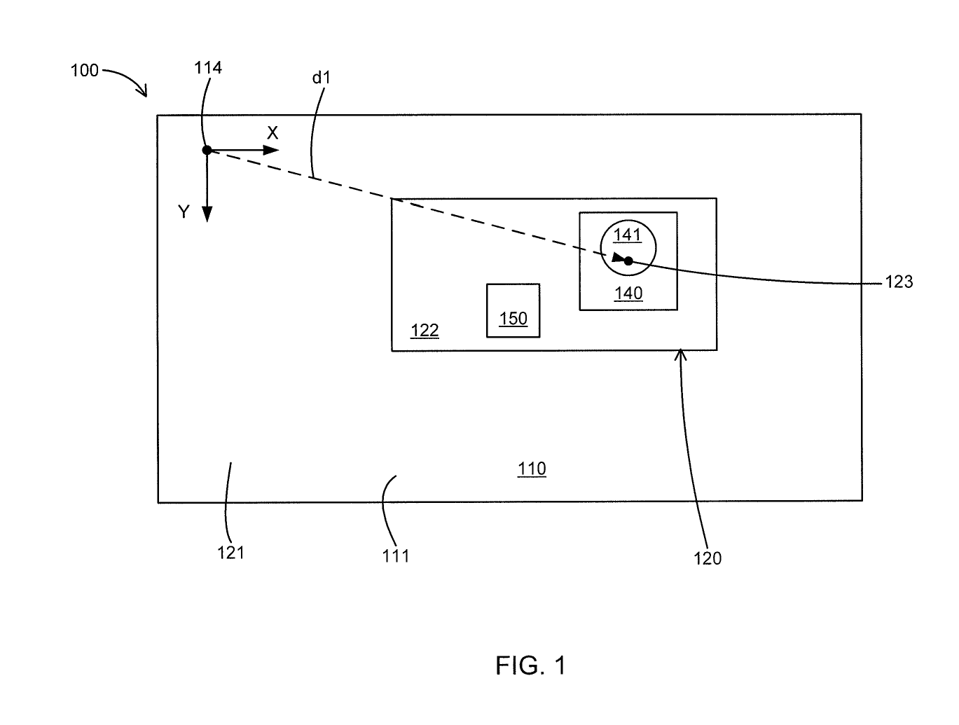

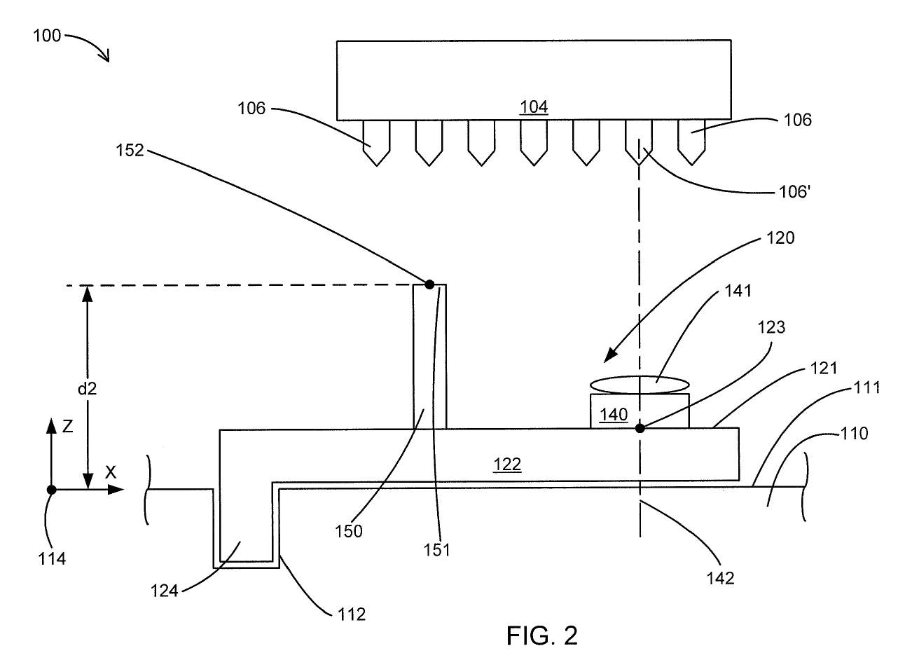

FIGS. 1 and 2 are schematic illustrations of a top view and a side view of a liquid handling system 100, respectively. The liquid handling system 100 includes a deck 110 and a head 104 (see FIG. 2). A calibration assembly 120 is shown removably coupled to the deck 110 of the liquid handling system 100. The liquid handling system 100 can be used to perform assays by placing a well plate, microtiter plate and/or microplate (not shown in FIGS. 1 and 2) on the deck 110 and directing the head 104 to deposit fluid into and/or remove fluid from the wells of the well plate, as described in further detail herein.

The deck 110 includes a top surface 111 and defines an alignment portion 112 (see FIG. 2) and a deck reference point 114. The deck reference point 114 corresponds to a predetermined location on the top surface 111 of the deck 110. As shown in FIGS. 1 and 2, the deck reference point 114 can be the origin or “zero point” for a three-dimensional Cartesian coordinate system including an X-axis defining an X-dimension, a Y-axis defining a Y-dimension and a Z-axis defining a Z-dimension, as shown in FIGS. 1 and 2. As shown in FIG. 1, the X-axis and the Y-axis of the three-dimensional coordinate system are parallel to the top surface 111 of the deck 110 with the X-axis being perpendicular to the Y-axis As shown in FIG. 2, the Z-axis of the three-dimensional coordinate system is perpendicular to the top surface 111 of the deck 110 with the Z-axis being perpendicular to the X-axis and the Y-axis. Said another way, the Z-axis is perpendicular to a plane defined by the X and Y axes. The three-dimensional coordinate system can be used in calibrating and/or aligning the head 104 of the liquid handling system 100 with respect to the deck 110, as described in further detail herein.

The top surface 111 can be coupled to and/or configured to receive one or more well plates (not shown in FIGS. 1 and 2). A well plate (e.g., a microtiter plate and/or a microplate) can be a plate defining multiple wells and/or recesses configured to accept fluid dispensed from multiple pipettes 106 of the head 104 and/or retain fluid to be removed and/or transported by the pipettes 106, as further described herein. Similarly stated, the well plate can define multiple volumes that function similar to test tubes.

The top surface 111 of the deck 110 defines at least one predetermined position (e.g., a deck plate) at which a well plate (not shown in FIGS. 1 and 2) can be placed. The predetermined position can be defined with reference to the deck reference point 114. As such, a well plate is placed in substantially the same position with respect to the deck reference point 114 each time it is recoupled to the top surface 111 of the deck 110. In this manner, the alignment and/or position of the head 104 relative to the well plate can be accurately and/or precisely controlled each time a well plate is coupled to the deck 110 and/or each time the head 104 is moved relative to the deck 110 during an assay. In some embodiments, the calibration assembly 120 can be removably coupled to the top surface 111 at the same predetermined position at which the well plate can be placed, as further described in detail herein.

The alignment portion 112 of the deck 110 can be any suitable structure and/or mechanism configured to matingly engage a corresponding alignment portion of a well plate and/or an alignment portion 124 of the calibration assembly 120 such that movement of the well plate and/or calibration assembly 120 with respect to the deck 110 is limited. In some embodiments, the alignment portion 112 of the deck 110 can be a notch, opening and/or recess defined by the deck 110 that is configured to receive a protrusion of the well plate and/or calibration assembly 120. In other embodiments, the alignment portion of the deck can be a protrusion configured to be inserted into a notch, opening and/or recess defined by the well plate and/or calibration assembly.

As shown in FIG. 2, the head 104 can be removably coupled to a set of pipettes 106. In some embodiments, the head 104 includes a set of cones (not shown in FIGS. 1 and 2) configured to removably couple the pipettes 106 to the head 104. In such embodiments, each cone can be configured to matingly engage an end portion of a pipette 106, as described in further detail herein. For example, each cone can engage a pipette 106 using a friction fit, a suction mechanism, a notch-protrusion mechanism and/or the like. In other embodiments, the pipettes can be fixedly coupled to the head.

The pipettes 106 can be of any suitable type and/or size. In some embodiments, for example, the pipettes 106 can be single piece glass pipettes, electronic pipettes, vacuum pipettes, air-displacement pipettes, positive-displacement pipettes, micropipettes and/or the like. The pipettes 106 can be configured to transport a measured volume of liquid. Through the pipettes 106, liquid can be dispensed and/or received from wells of a well plate (not shown in FIGS. 1 and 2). To improve the accuracy and/or precision of the fluid transfer, process, the head 104 can be calibrated such that each pipette 106 is aligned with a well of the well plate, as described in further detail herein.

The head 104 can include a liquid transfer mechanism configured to retain liquid in the pipettes 106, draw liquid into the pipettes and/or release liquid from the pipettes 106. The liquid transfer mechanism can include, for example, one or more vacuum pumps, fluid capillaries, and/or the like.

The head 104 is movably coupled to the deck 110 and is configured to move with respect to the top surface 111 of the deck 110 in three dimensions (X, Y and Z, as shown in FIGS. 1 and 2). Accordingly, the head 104 can move to different positions relative to the plane of the deck 110 in the X-dimension and the Y-dimension. For example, the head 104 can move such that it is aligned with various well plates disposed on the top surface 111 of the deck 110. The head 104 can also move to different positions relative to the deck 110 in the Z-dimension (or vertical dimension). For example, the head 104 can move nearer to or further away from the top surface 111 of the deck 110. Said another way, the distance between the head 104 and the deck 110 can vary as the head 104 is moved with respect to the deck 110 in the Z-dimension. This allows the head 104 to move the pipettes 106 coupled to the head 104 between a volume defined by wells of a well plate and a volume outside the wells of the well plate. In such a manner, the head 104 can dispense and/or receive fluid from the wells of a first well plate and transfer fluid to the wells of a second well plate, as further described in detail herein.

The calibration assembly 120 is used to initialize, zero and/or calibrate a position of the head 104 relative to the top surface 111 of the deck 110, as described herein. Said another way, the calibration assembly 120 can be used to ensure that the pipettes 106 of the head 104 are properly aligned, zeroed and/or calibrated with the wells of a well plate disposed at the predetermined position on the top surface 111 of the deck 110.

The calibration assembly 120 includes a calibration member 122, an imaging device 140 and a proximity sensor 150. The calibration member 122 is configured to be removably coupled to the deck 110 in at least one predetermined position on the deck 110. In some embodiments, the calibration member 122 has the same length (i.e., dimension in the X-dimension) and width (i.e., dimension in the Y-dimension) of a well plate. In such embodiments, the calibration member 122 is configured to be placed at the predetermined position on the top surface 111 of the deck 110 configured to receive the well plate. In other embodiments, the calibration member 122 is configured to be removably coupled to the deck at a position unrelated to a position configured to receive a well plate. In some embodiments, the calibration member 122 can be a plate, a block, an assembly of rods and/or any other suitable structure.

The calibration member 122 includes an alignment portion 124 and defines a top surface 121. In some embodiments, the top surface 121 of the calibration member is substantially parallel to the top surface 111 of the deck 110. In other embodiments, the top surface of the calibration member is non-parallel to the top surface of the deck.

The alignment portion 124 can be any suitable structure and/or mechanism configured to matingly engage the alignment portion 112 of the deck 110 such that movement of the calibration member 122 with respect to the deck 110 is limited during calibration. Said another way, when the alignment portion 124 is engaged with the alignment portion 112 the calibration member 122 is fixed with respect to a predetermined location of the deck 110 within a tolerance. In some embodiments, for example, the alignment portion 124 can be a protrusion configured to be received by a notch, opening and/or recess defined by the deck 110. In other embodiments, the alignment portion of the calibration member can be a notch, opening and/or recess configured to receive a protrusion of the deck.

The imaging device 140 and the proximity sensor 150 are coupled to the calibration member 122 such that a position of the imaging device 140 and a position of the proximity sensor 150 are substantially fixed with respect to the calibration member 122. Said another way, the imaging device 140 and the proximity sensor 150 are coupled to the calibration member 122 such that the imaging device 140 and the proximity sensor 150 do not move with respect to the calibration member 122. The imaging device 140 and the proximity sensor 150 can be coupled to the calibration member 122 by any suitable structure and/or mechanism. In some embodiments, for example, the imaging device 140 and/or the proximity sensor 150 can be coupled to the calibration member 122 by a notch/protrusion assembly, a bracket, a snap connector, a threaded connector (e.g., a screw) and/or any other type of connector.

The imaging device 140 includes a lens 141 and is configured to receive and/or process light to form an image. The imaging device can be any suitable imaging device. In some embodiments, for example, the imaging device can be a charge-coupled device (CCD) camera, a thermographic camera, and/or the like.

As shown in FIG. 2, the lens 141 of the imaging device 140 is configured to capture and/or receive light in the direction of the head 104. Said another way, the lens 141 of the imaging device 140 is pointed at the head 104. Similarly stated, the lens 141 of the imaging device is configured to be disposed such that the imaging device 140 can produce an image of at least a portion of the head 104. As such, the imaging device 140 is mounted on and/or coupled to the calibration member 122 such that the lens 141 is substantially parallel to the top surface 121 of the calibration member 122 and/or the deck 111. Similarly stated, the imaging device 140 is mounted on and/or coupled to the calibration member 122 such that an axis 142 of the lens 141 is normal and/or perpendicular to the top surface 121 of the calibration member 122 and/or the top surface 111 of the deck 110. In other embodiments, the axis 142 of the lens defines an acute angle with the top surface of the deck.

The imaging device 140 is configured to produce an image of a portion of the head 104. Such an image can be used to calibrate the position of the head 104 with respect to the deck 110 in the X and the Y-dimensions. For example, in some embodiments, a user can view a portion of the head 104 (e.g., a pipette 106, cone and/or other portion of the head 104) using the imaging device 140 (e.g., on a display) to manually calibrate the position of the head 104 with respect to the deck 110 in the X and the Y-dimensions, as described in further detail herein. In other embodiments, video analytics can be used to automatically calibrate the position of the head 104 with respect to the deck 110 in the X and the Y-dimensions, as described in further detail herein.

The first calibration reference point 123 is defined by the imaging device 140 and/or the calibration member 122, and is disposed at a first predetermined position with respect to the deck reference point 114 when the calibration member 122 is coupled to the deck 110 (see e.g., FIG. 1). The first predetermined position can be defined with respect to the deck reference point 114 by a first vector d1. The first predetermined position (and thus the first vector d1) is substantially the same each time the calibration member 122 is coupled to the deck 110 and the head 104 is calibrated. Similarly stated, the first predetermined position is fixed with respect to the deck reference point 114.

The imaging device 140 and the calibration member 122 are collectively configured such that the axis 142 of the lens intersects the first calibration reference point 123. Similarly stated, the axis 142 of the lens extends in the Z-dimension through the first calibration reference point 123. As such, the imaging device 140 is placed in the same position with respect to the deck reference point 114 each time the head 104 is calibrated. This ensures that the head 104 is accurately initialized, zeroed and/or calibrated in the X and the Y-dimensions, as further described herein. During calibration, a predetermined portion of the head 104 (e.g., a calibration pipette 106′, cone and/or other portion of the head 104) is aligned with the axis 142 of the lens to calibrate the head 104 in the X and Y-dimensions, as described in further detail herein.

The proximity sensor 150 includes a sensing tip 151 and defines a second calibration reference point 152. In some embodiments, the proximity sensor 150 can be a contact sensor such as a GT2 High-Accuracy Digital Contact Sensor manufactured by Keyence Corp. In other embodiments, the proximity sensor can be a non-contact proximity sensor such as, for example, an infrared proximity sensor, an inductive proximity sensor, a capacitive proximity sensor, an optical sensor, a magnetic proximity sensor and/or the like.

The sensing tip 151 is configured to sense the proximity of a portion of the head 104 (e.g., a pipette 106, cone and/or other portion of the head 104). In some embodiments, for example, when the portion of the head contacts the sensing tip 151, the proximity sensor 150 is configured to send a signal (e.g., an electronic output) to a user and/or a computer processor indicating that the portion of the head contacted the sensing tip 151. In other embodiments, the proximity sensor is configured to send a signal to the user and/or the computer processor indicating that the portion of the head is a predetermined distance from the sensing tip. Such a signal can produce, for example, a visual indication such as a indication on a display and/or illuminating a light emitting diode (LED), an audio indication, a haptic indication, and/or the like.

The second calibration reference point 152 is defined by the proximity sensor 150 at the sensing tip 151. The proximity sensor 150 and the calibration member 122 are collectively configured such that the second calibration reference point 152 is disposed at a second predetermined position with respect to the deck reference point 114 (see e.g., FIG. 2) in the Z-dimension. Said another way, the second calibration reference point 152 is disposed at a predetermined distance (e.g., height) above the top surface 111 of the deck 110 when the calibration assembly 120 is coupled to the deck 110. The second predetermined position can be defined with respect to the deck reference point 114 by a second vector d2. The second predetermined position (and thus the second vector d2) is substantially the same each time the calibration member 122 is recoupled to the deck 110. Said another way, each time the calibration member 122 is recoupled to the deck 110, it is recoupled to the deck 110 at the same position, within a tolerance. Similarly stated, the second predetermined position is substantially fixed with respect to the deck reference point 114. As such, the sensing tip 151 is placed in the same position with respect to the deck reference point 114 each time the head 104 is calibrated. This ensures that the head 104 can be accurately initialized, zeroed and/or calibrated in the Z-dimension, as further described herein.

In use, the head 104 of the liquid handling system 100 can be initialized, zeroed and/or calibrated with respect to the deck 110 using the calibration assembly 120. The calibration assembly 120 is disposed on the deck 110 such that the alignment portion 112 of the deck 110 and the alignment portion 124 of the calibration member 122 are engaged. In this manner, the position of the calibration assembly 120 with respect to the deck 110 is substantially fixed in a predetermined position, as described above. More particularly, the calibration assembly 120 is disposed on the deck 110 such that the first calibration reference point 123 is disposed at the first predetermined position with respect to the deck reference point 114 in a plane defined by the X and Y-dimensions. Similarly, the calibration assembly 120 is positioned on the deck 110 such that the second calibration point 152 is disposed at the second predetermined position with respect to the deck reference point 114 in the Z-dimension. Thus, the calibration assembly 120 is placed at substantially the same position on the deck 110 each time the head 104 is calibrated.

The head 104 is then positioned over and/or above the calibration assembly 120 (see e.g., FIG. 2). Similarly stated, the head is positioned such that a portion of the head 104 is aligned with a portion of the calibration assembly 120 in the Z-dimension. Using the imaging device 140, a reference portion of the head (e.g., a calibration pipette 106′) is aligned with the axis 142 of the lens 141. Said another way, using the imaging device 140 to guide the movement of the head 104, the calibration pipette 106′ (referred to as a calibration pipette) is positioned at the first predetermined position with respect to the deck reference point 114 in the plane defined by the X and Y-dimensions. In some embodiments, an image of the head 104 produced by the imaging device 140 can be projected on a display. In such embodiments, a user can manually align the calibration pipette 106′ with the axis 142. More particularly, while referencing the image on the display, the user can use control buttons to move the head 104 until the calibration pipette 106′ is substantially aligned with the axis 142 of the lens. In other embodiments, video analytics can be used to automatically align the calibration pipette 106′ with the axis, as further described herein.

After the calibration pipette 106′ (or other portion of the head 104) is aligned with the axis 142, a first calibration parameter can be set. The first calibration parameter corresponds to the position of the first calibration reference point 123 in the plane defined by the X and Y-dimensions. Based on the first calibration parameter, the positions of other locations on the deck 110 in the X and Y-dimensions can be calculated. For example, the positions of various well plates on the deck 110 in the X and Y-dimensions can be calculated using the first calibration parameter and information about the other locations on the deck 110 (e.g., the locations of the other locations on the deck 110 with respect to the first calibration reference point 123). Accordingly, the head 104 can move accurately and repeatably to the location of various well plates in the X and Y-dimensions based on the first calibration parameter.

The head 104 can then be moved in the Z-dimension in the direction of the sensing tip 151 of the proximity sensor 150. Similarly stated, the head 104 can be moved closer to the sensing tip 151 in the Z-dimension. Said another way, the distance between the head 104 and the sensing tip 151 in the Z-dimension can be reduced. The head 104 is moved until the proximity sensor 150 senses the head 104. In some embodiments, for example, the head 104 is lowered until a portion of the head 104 (e.g., a pipette 106, cone and/or other portion of the head 104) touches the sensing tip 151 of the proximity sensor 150. In other embodiments, the head 104 is lowered until a portion of the head 104 is close enough to the proximity sensor such that the proximity sensor 150 can determine the distance in the Z-dimension between the second calibration reference point 152 and the head.

After the sensing tip 151 of the proximity sensor 150 senses the proximity of the head 104, a second calibration parameter can be set. The second calibration parameter corresponds to the position of the second calibration reference point 152 in the Z-dimension. Based on the second calibration parameter, the positions of other locations on the deck 110 in the Z-dimension can be calculated. For example, the positions of various well plates on the deck 110 in the Z-dimension can be calculated using the second calibration parameter and information about the other locations on the deck 110. Similarly stated, based on the second calibration parameter, the height of various well plates placed on the deck 110 can be calculated. This allows the head 104 to accurately and repeatably move to the location of various well plates in the Z-dimension (e.g., height).

After the head 104 has been successfully calibrated by setting and/or determining the first calibration parameter and the second calibration parameter, the liquid handling system 100 can be used to perform assays. Based on the first calibration parameter and the second calibration parameter, the head 104 can automatically be positioned in a desired location in the X-dimension, Y-dimension and Z-dimension with respect to the top surface 111 of the deck 110 (e.g., on which the well plates are disposed). In some embodiments, for example, the pipettes 106 of the head 104 can be automatically positioned within the wells of the well plates. Additionally, the pipettes 106 can be automatically moved between wells of various well plates positioned on the deck 110. This allows the pipettes 106 to precisely deposit fluid and/or remove fluid from the wells of the well plates during analysis and/or experimentation.

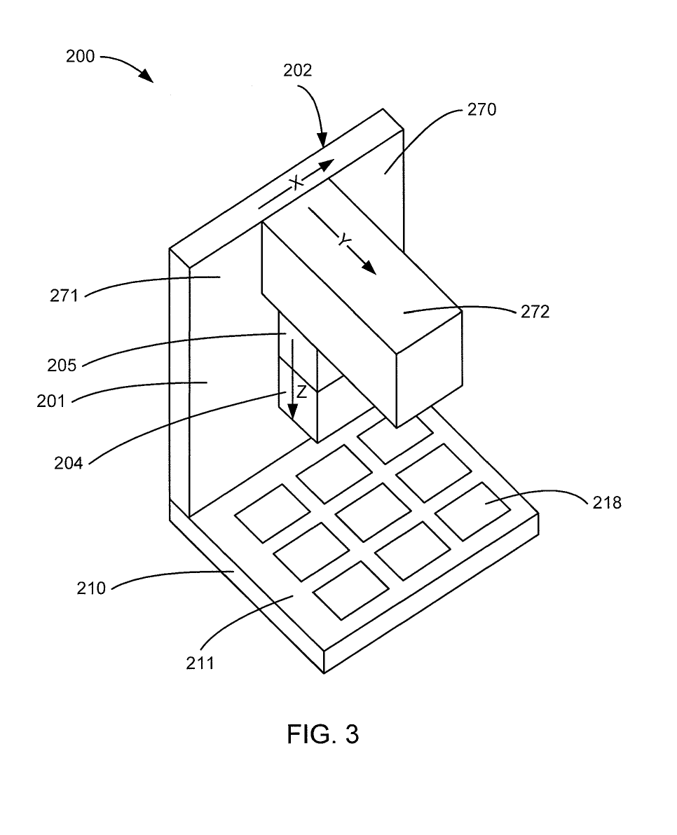

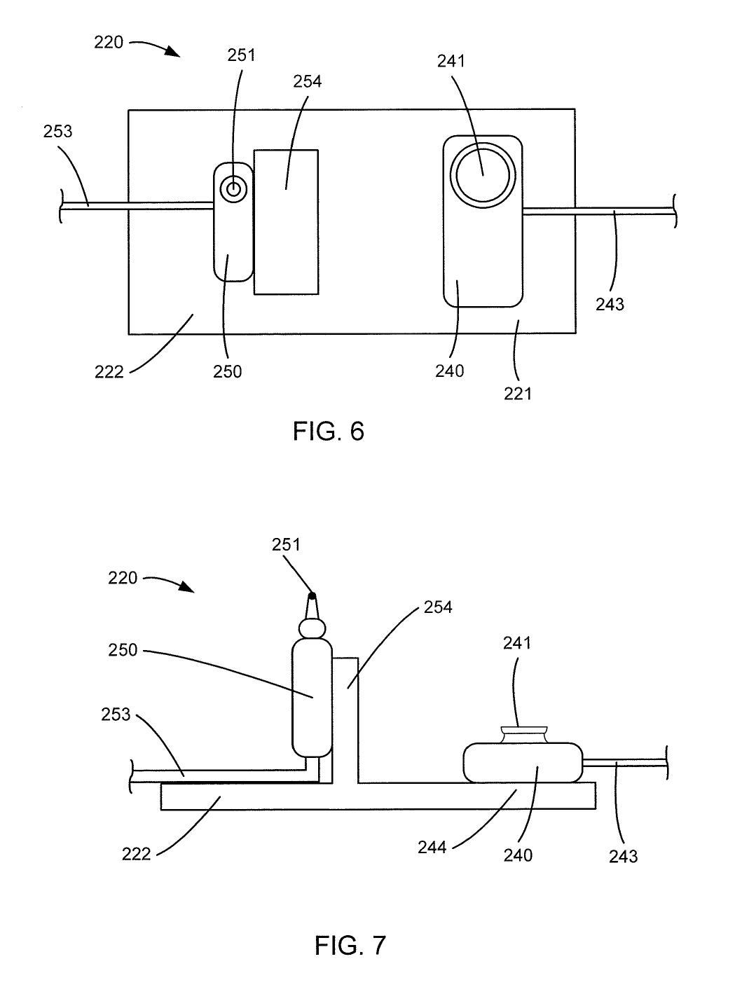

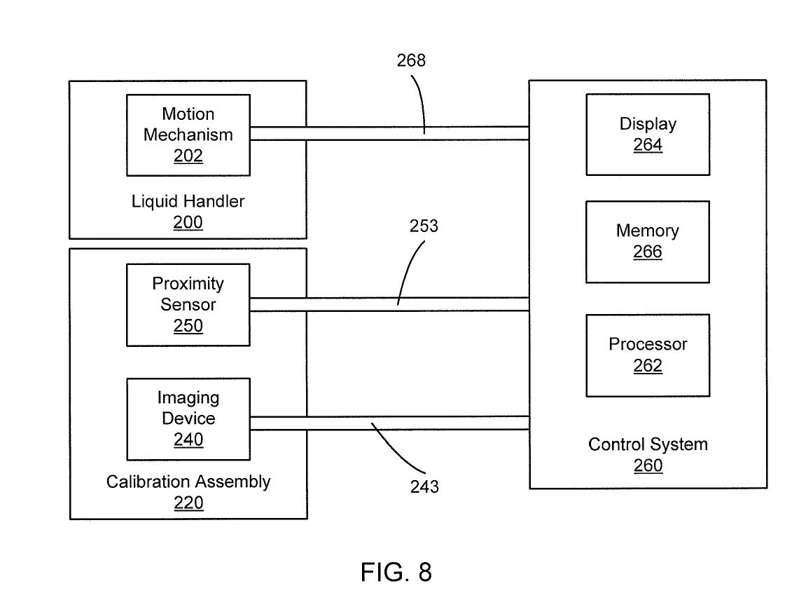

FIGS. 3-10 illustrate a liquid handling system, according to another embodiment. The liquid handling system includes a liquid handler 200 (FIGS. 3-5) and a control system 260 (FIGS. 8-10). A calibration assembly 220 (FIGS. 6 and 7) is configured to be coupled to the liquid handling system, as described in further detail herein.

FIG. 3 is a front perspective view of the liquid handler 200. The liquid handler 200 includes a frame 201 and a deck 210. Similar to the deck 110, the deck 210 includes a top surface 211 defining one or more deck plates 218 (i.e., predetermined positions on the top surface 211) at which well plates (not shown in FIG. 3) can be placed and/or removably coupled to the deck 210. In some embodiments, similar to the liquid handling system 100, the positions of the deck plates 218 can be defined with reference to a deck reference point (not shown in FIG. 3). Accordingly, the position of each deck plate 218 is substantially fixed and/or stationary (within a tolerance) with respect to the deck 210 and with respect to the other deck plates 218.

The deck plates 218 are configured to receive the well plates such that a position of the well plates is substantially fixed and/or stationary (within a tolerance) with respect to the deck 210. Similarly stated, the well plates are configured to engage the deck plates 218 when the liquid handler 200 is in use. The deck plates 218 are configured to retain the well plates using any suitable engagement mechanism such as, for example, a notch defined by a deck plate 218 configured to receive a protrusion of a well plate, a protrusion of a deck plate 218 configured to be inserted into a notch defined by a well plate, a portion of a well plate configured to be placed over and/or around a portion of a deck plate 218, a snap connector, and/or any other type of connector.

As shown in FIG. 3, in some embodiments, the top surface 211 defines nine deck plates 218. In other embodiments, the top surface 211 can define any number of deck plates 218. For example, the top surface can define between nine and forty-eight deck plates. In still other embodiments, the top surface can define less than nine deck plates or more than forty-eight deck plates.

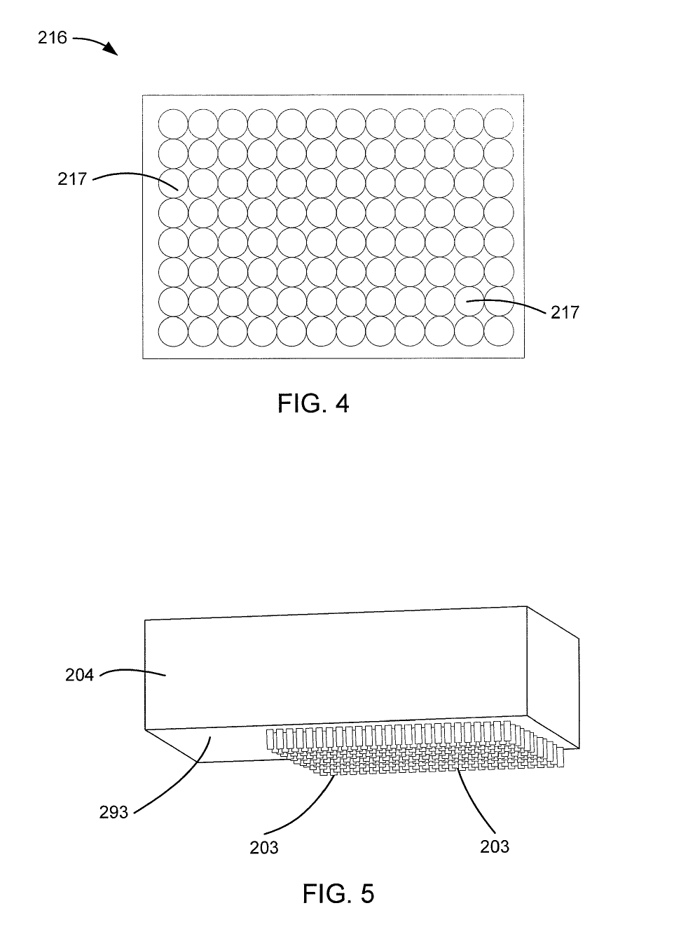

FIG. 4 is a top view of a well plate 216, according to an embodiment. The well plate 216 defines multiple wells 217 (e.g., test tubes, troughs, or the like) that each define a volume. While shown in FIG. 4 has having 96 wells 217, in other embodiments, the well plate 216 can have any number of wells. For example, in some embodiments, a well plate can have greater than 96 wells (e.g., 108, 144, 384, etc.) or less than 96 wells (e.g., 8, 16, 48, 80, etc.). As discussed herein, samples disposed within the wells 217 can be used to perform assays and/or experimentation when the well plate 216 is coupled to the deck 210 (e.g., at a deck plate 218).

Referring again to FIG. 3, the frame 201 of the liquid handler 200 includes a motion mechanism 202 and a head 204. The motion mechanism 202 includes a first portion 270, a second portion 272, a head adapter 205 and a control connector 268 (see e.g., FIG. 8). The first portion 270 of the motion mechanism 202 defines a surface 271 perpendicular to the top surface 211 of the deck 211. Additionally, the first portion 270 defines an X-axis (defining an X-dimension) in a first direction and a Z-axis (defining a Z-dimension) in a second direction as part of a three dimensional Cartesian coordinate system. The X-axis is substantially perpendicular, normal and/or orthogonal to the Z-axis. The first portion 270 is coupled to the deck 210 such that the first portion 270 of the motion mechanism 202 does not move and/or is stationary with respect to the deck 210. Additionally, the surface 271 defines a substantially right angle with respect to the top surface 211 of the deck 210. Said another way, the surface 271 is substantially perpendicular, normal and/or orthogonal with respect to the top surface 211 of the deck 210. In other embodiments, the surface of the first portion of the motion mechanism can define any other suitable angle with respect to the top surface of the deck.

The second portion 272 of the motion mechanism 202 is disposed perpendicular, normal and/or orthogonal to the surface 271 of the first portion 270 and extends from the surface 271 such that the second portion 272 is disposed above and/or over a portion of the top surface 211 of the deck 210. Similarly stated, the second portion 272 is substantially aligned with a portion of the deck 210 in the Z-dimension. The second portion 272 is movably coupled to the first portion 270 such that the second portion 272 can move with respect to the surface 271 along the X-axis and the Z-axis. This allows the second portion 272 to move with respect to the top surface 211 of the deck 210 along the X-axis and the Z-axis. As further described in detail herein, the second portion 272 is configured to move the head 204 with respect to the deck 210 along the X-axis and the Z-axis.

The second portion 272 defines a Y-axis (defining a Y-dimension) in a third direction as part of the three dimensional coordinate system. The Y-axis is substantially perpendicular, normal and/or orthogonal to the X-axis and the Z-axis. Similarly stated, the Y-axis extends perpendicular to the surface 271 of the first portion 270.

The head adapter 205 is movably coupled to the second portion 272 and is configured to move with respect to the second portion 272 along the Y-axis. Such movement can be along a bottom surface of the second portion 272 (i.e., a surface of the second portion 272 directly facing, parallel to and/or disposed above the top surface 211 of the deck 210). As further described herein, this allows the head adapter 205 to move the head 204 with respect to the deck 210 along the Y-axis.

The head adapter 205 is configured to be coupled to the head 204 of the liquid handler 200. As such, the head adapter 205 includes a coupling mechanism (not shown in FIG. 3). In some embodiments, for example, the head adapter 205 is fixedly coupled to the head 204 such that the head 204 cannot be removed and/or separated from the head adapter 205. In other embodiments, the head is removably coupled to the head adapter using any suitable connector such as, for example, a snap connector, a tabbed connector, a locking mechanism with a locked position and a release position, a ball/detent connector, and/or the like.

The control connector 268 (see e.g., FIG. 8) can be any suitable connection configured to operatively couple the motion mechanism 202 to a control system 260 (see e.g., FIG. 8). The control system 260 can be configured to control the movement of the motion mechanism (e.g., the motion of the head 204 along the X-axis in the X-dimension, Y-axis in the Y-dimension and Z-axis in the Z-dimension), as further described in detail herein. In some embodiments, the control connector 268 can be an electrical cable or an optical cable. For example, the control connector 268 can be a Universal Serial Bus (USB) cable, a serial cable, and/or the like. In other embodiments, the control connector can be an antenna that facilitates a wireless connection with the control system. In such embodiments, the control connector can operatively couple the motion mechanism to the control system over a network, such as, for example, a wireless local area network (WLAN) or the like.

FIG. 5 is a side perspective view of a portion of the head 204. The head 204 includes multiple cones 203 (e.g., pipette acceptors) disposed on a bottom surface 293 of the head 204. Similarly stated, the cones 203 are disposed on a bottom surface 293 of the head 204 configured to face and/or be disposed above and/or parallel to the top surface 211 of the deck 210. As shown in FIG. 5, the cones 203 can be aligned on the head 204 in multiple rows and columns. Each cone 203 can be spaced with respect to the other cones 203 a distance substantially similar to a distance between the wells of a well plate (e.g., wells 217 of well plate 216). This allows each cone 203 to be aligned with a well of a well plate when the head 204 is disposed above and/or aligned with the well plate.

Each cone 203 is configured to be coupled to, matingly engage and/or retain an end portion of a pipette (not shown in FIG. 5). In some embodiments, each cone 203 can be coupled to, engage and/or retain an end portion of a pipette in any suitable manner, such as, for example, with a mechanical locking mechanism such as an indent/protrusion mechanism, with a suction member, using friction between the pipette and the cone 203, and/or the like. When coupled to the cones 203, the pipettes can extend from the surface 293 of the head 204 toward the top surface 211 of the deck 210 in the Z-dimension. Similarly stated, the pipettes can extend from the surface 293 of the head 204 such that an axis defined by each pipette is substantially perpendicular, normal and/or orthogonal to the deck 210. As such, the pipettes can engage, contact and/or be disposed within a volume defined by a well of a well plate coupled to the deck 210 when the head 204 is disposed above and/or aligned with the well plate. In other embodiments, instead of having cones to engage pipettes, the pipettes are themselves fixedly coupled to the head.

The head 204 can include a liquid transfer mechanism configured to retain liquid in the pipettes, draw liquid into the pipettes and/or release liquid from the pipettes. The liquid transfer mechanism can include, for example, one or more vacuum pumps, fluid capillaries, and/or the like.

FIGS. 6 and 7 show a top view and a side view of the calibration assembly 220, according to an embodiment. The calibration assembly 220 can be used to initialize, zero and/or calibrate the head 204 of the liquid handler 200 with respect to the deck 210, as further described in detail herein. The calibration assembly 220 includes a calibration member 222, an imaging device 240 and a proximity sensor 250.

The calibration member 222 is a plate and/or a block configured to be removably coupled to the deck 110 in at least one predetermined position on the deck 210. In some embodiments, the calibration member 222 has the same length (i.e., dimension along the X-axis) and width (i.e., dimension along the Y-axis) as a well plate. In such embodiments, the calibration member 222 is configured to be removably coupled to and/or placed on the deck 110 at the deck plates 218 defined by the top surface 211 of the deck 210. In other embodiments, the calibration member 222 is configured to be removably coupled to and/or placed on the deck at a position (e.g., a calibration position) unrelated to a position configured to receive a well plate.

The calibration member 222 includes an alignment portion (not shown in FIGS. 6 and 7), a first mounting portion 244 and a second mounting portion 254 and defines a top surface 221. In some embodiments, the top surface 221 of the calibration member 222 is substantially parallel to the top surface 211 of the deck 210 when the calibration member is coupled to the predetermined position on the top surface 211 of the deck 210. In other embodiments, the calibration member is coupled to the predetermined position such that the top surface of the calibration member is non-parallel to the top surface of the deck.

The alignment portion of the calibration member 222 can be substantially similar to the alignment portion 124 of the calibration member 120, shown and described above. As such, the alignment portion of the calibration member 222 can be any suitable structure and/or mechanism configured to engage the deck 210 such that movement of the calibration member 222 with respect to the deck 210 is limited during calibration. Said another way, when the alignment portion of the calibration member 222 is engaged with the deck 210, the calibration member is fixed with respect to a predetermined location of the deck 210. In some embodiments, for example, the alignment portion can be a protrusion configured to be received by a notch, opening and/or recess defined by the deck 210. In other embodiments, the alignment portion of the calibration member can be a notch, opening, and/or recess configured to receive a protrusion of the deck and/or any other type of connector.

The first mounting portion 244 can be any connector configured to mount the imaging device 240 to the top surface 221 of the calibration member 222 such that movement of the imaging device 240 with respect to the calibration member 222 is limited. Said another way, when the imaging device 240 is coupled to the calibration member 222 via the first mounting portion 244, the position of the imaging device 240 with respect to the calibration member 222 is substantially fixed. In some embodiments, for example, the first mounting portion 244 can be a portion of a notch/protrusion assembly, a bracket, a threaded connector (e.g., a screw), a snap connector and/or any other type of connector.

The second mounting portion 254 can be any connector configured to mount the proximity sensor 250 to the calibration member 222 such that movement of the proximity sensor 250 with respect to the calibration member 222 is limited. Said another way, when the proximity sensor 250 is coupled to the calibration member 222 via the second mounting portion 254, the position of the proximity sensor 250 with respect to the calibration member is substantially fixed. As shown in FIG. 7, the second mounting portion 254 can include a portion disposed substantially perpendicular to the top surface 221 of the calibration member 222 to which the proximity sensor 250 can be mounted. This allows the tip 251 of the proximity sensor 250 to be aligned and/or disposed in a vertical direction along the Z-axis when the calibration assembly 220 is coupled to the deck 210, as described in further detail herein. Said another way, an axis defined by the proximity sensor 250 can be perpendicular, normal and/or orthogonal to the bottom surface 293 of the head 204 when the calibration member 222 is coupled to the deck 210 and the head 204 is positioned above the calibration member 222. In some embodiments, the second mounting portion 254 can include a notch/protrusion assembly, a bracket, a threaded connector (e.g., a screw), a snap connector and/or any other type of connector.

The imaging device 240 includes a lens 241, a control connector 243 and a mounting portion (not shown in FIGS. 6 and 7). The imaging device 240 can be any suitable imaging device. In some embodiments, for example, the imaging device 240 can be a charge-coupled device (CCD) camera. In other embodiments, the imaging device can be a thermographic camera, and/or the like. The control connector 243 is configured to operatively couple the imaging device 240 to the control system 260 (FIG. 8), and can be structurally similar to the control connector 268, described above.

The mounting portion (not shown in FIGS. 6 and 7) of the imaging device 240 is configured to matingly engage, couple to and/or receive the first mounting portion 244 of the calibration member 222 to mount and/or couple the imaging device 240 to the top surface 221 of the calibration member 222. As such, the mounting portion of the imaging device 240 can be complimentary to the first mounting portion 244 of the calibration member 222. Accordingly, the mounting portion of the imaging device 240 can be a notch/protrusion assembly, a bracket, threaded connector (e.g., a screw), a snap connector and/or any other type of connector.

The imaging device 240 is coupled and/or mounted to the calibration member 222 such that movement of the imaging device 240 with respect to the calibration member 222 is limited. Similarly stated, the imaging device 240 is coupled and/or mounted to the calibration member 222 such that a position of the imaging device 240 is substantially fixed with respect to the calibration member 222. Said another way, the imaging device 240 is coupled to the calibration member 222 such that the imaging device 240 does not move with respect to the calibration member 222 (e.g., beyond a tolerance).

The lens 241 of the imaging device 240 is configured to capture and/or receive light in the direction of the head 204 (i.e., along the Z-axis). Said another way, the lens 241 of the imaging device 240 is pointed at the head 204 when the calibration assembly 220 is coupled to the deck 210. Similarly stated, the lens 241 of the imaging device is configured to be disposed such that the imaging device 240 can produce an image of at least a portion of the head 204 when at least a portion of the head 204 is aligned with the lens 241 in along the Z-axis. As such, the imaging device 240 is mounted on and/or coupled to the calibration member 222 such that the lens 241 is substantially parallel to the top surface 221 of the calibration member 222 and/or the deck 211. Similarly stated, the imaging device 240 is mounted on and/or coupled to the calibration member 222 such that an axis (not shown in FIGS. 6 and 7) of the lens 241 is normal and/or perpendicular to the top surface 221 of the calibration member 222 and/or the top surface 211 of the deck 210 when the calibration assembly 220 is coupled to the deck 210.

The imaging device 240 is configured to produce an image of a bottom surface 293 of the head 204 (see e.g., FIG. 10). The image can be used to initialize, zero and/or calibrate the head 204 with respect to the deck 210 in the X and the Y-dimensions. For example, in some embodiments, a user can view an image of the bottom surface 293 of the head 204 produced by the imaging device 240 (see e.g., FIG. 10). Viewing the image, the user can manually calibrate, zero and/or initialize the position of the head 204 with respect to the deck 210 in the X and the Y-dimensions, as described in further detail herein. In other embodiments, video analytics can be used to automatically calibrate, zero and/or initialize the position of the head with respect to the deck in the X and the Y-dimensions, as described in further detail herein.

When the calibration assembly 220 is coupled to and/or placed on the deck 210, the lens 241 is positioned at a first predetermined position on the deck 210 in relation to the X-axis and the Y-axis. Similarly stated, the location on the deck 210 at which the lens 241 is disposed is substantially the same each time the calibration assembly 220 is recoupled to the deck 210. Accordingly, the first predetermined position is substantially the same each time the head 204 is calibrated, zeroed and/or initialized. As such, the imaging device 240 is placed in the same position on the deck 210 along the X-axis and Y-axis each time the head 204 is calibrated, zeroed and/or initialized. This ensures that the head 204 is accurately calibrated, zeroed and/or initialized in the X and the Y-dimensions, as further described herein.

The proximity sensor 250 includes a sensing tip 251, a control connector 253 and a mounting portion (not shown in FIGS. 6 and 7). In some embodiments, the proximity sensor 250 can be a contact sensor such as a GT2 High-Accuracy Digital Contact Sensor manufactured by Keyence Corp. In other embodiments, the proximity sensor can be a non-contact proximity sensor such as, for example, an infrared proximity sensor, an inductive proximity sensor, a capacitive proximity sensor, an optical sensor, a magnetic proximity sensor and/or the like. The control connector 253 can be structurally similar to the control connector 268, described above.

The sensing tip 251 is configured to sense the proximity of a portion of the head 204 (e.g., a pipette, cone and/or other portion). In some embodiments, for example, when the portion of the head 204 contacts the sensing tip 251, the proximity sensor 250 is configured to send a signal (e.g., an electronic output) to a processor 262 of a control system 260 (FIG. 8) indicating that the portion of the head 204 is in contact with the sensing tip 251. In other embodiments, the proximity sensor is configured to send a signal to the processor 262 indicating that the portion of the head 204 is a predetermined distance from the sensing tip. Such a signal can produce, for example, a visual indication such as a indication on a display and/or illuminating a light emitting diode (LED), an audio indication, a haptic indication, and/or the like.

When the calibration assembly 220 is coupled to and/or placed on the deck 210, the sensing tip 251 is positioned at a second predetermined position on the deck 210 with respect to the Z-axis. Said another way, the sensing tip 251 is disposed at a predetermined height above the top surface 211 of the deck 210 when the calibration assembly 220 is coupled to and/or disposed on the deck 210. The second predetermined position is substantially the same each time the head 204 is calibrated, zeroed and/or initialized. As such, the sensing tip 251 is placed in the same position on the deck 210 along the Z-axis each time the head 204 is calibrated, zeroed and/or initialized. Said another way, each time the calibration assembly 220 is recoupled to the deck 210, the sensing tip 251 is at the predetermined position with respect to the Z-axis. This ensures that the head 204 is accurately initialized, zeroed and/or calibrated in the Z-dimension, as further described herein.

The mounting portion (not shown in FIGS. 6 and 7) of the proximity sensor 250 is configured to matingly engage, couple to and/or receive the second mounting portion 254 of the calibration member 222 to mount and/or couple the proximity sensor 250 to the calibration member 222 such that movement of the proximity sensor 250 with respect to the calibration member 222 is limited. In particular, in some embodiments, the proximity sensor 250 is coupled and/or mounted to the calibration member 222 such that a position of the proximity sensor 250 is substantially fixed with respect to the calibration member 222 in at least the Z-dimension. As such, the mounting portion of the proximity sensor 250 can be complimentary to the second mounting portion 254 of the calibration member 222. Accordingly, the mounting portion of the proximity sensor 250 can be a notch/protrusion assembly, a bracket, a threaded connector (e.g., a screw), a snap connector and/or any other type of connector.

FIG. 8 is a block diagram illustrating the control system 260 operatively coupled to the calibration assembly 220 and the liquid handler 200. The control system 260 includes a processor 262, a display 264, and a memory 266. In some embodiments, the control system 260 can be, for example, a computing entity (e.g., a personal computing device such as a desktop computer, a laptop computer, etc.), a mobile phone, a monitoring device, a personal digital assistant (PDA), and/or the like.

The memory 266 can be any suitable memory. In some embodiments, for example, the memory 266 can be random access memory (RAM), a memory buffer, a hard drive, read-only memory (ROM), erasable read only memory (EPROM), electronically erasable read only memory (EEPROM), and/or the like. The display 264 can be any device configured to produce an image or display associated with control signals related to the calibration assembly 220 and/or the liquid handler assembly 200. In some embodiments, for example, the display 264 can be a liquid crystal display (LCD), a cathode ray tube (CRT), a plasma display, and/or the like. The processor 262 can be any processor able to control the operation of the calibration assembly 220 and/or the liquid assembly 200.

As discussed above, the control system 260 is operatively coupled to the calibration assembly 220 and the liquid handler 200 via control connectors 268, 253 and 243. More specifically, the motion mechanism 202 of the liquid handler 200 is operatively coupled to the control system 260 via the control connector 268, the proximity sensor 250 of the calibration assembly 220 is operatively coupled to the control system 220 via the control connector 253, and the imaging device 240 of the calibration assembly 220 is operatively coupled to the control system 260 via the control connector 243. Through the control connectors 268, 253, 243, control signals can be sent between the motion mechanism 202, the proximity sensor 250, the imaging device 240 and the control system 260. While shown as having three separate control connectors 243, 253, 268, in other embodiments, a single control connector can be used to operatively couple the control system to the calibration assembly and the liquid handler.

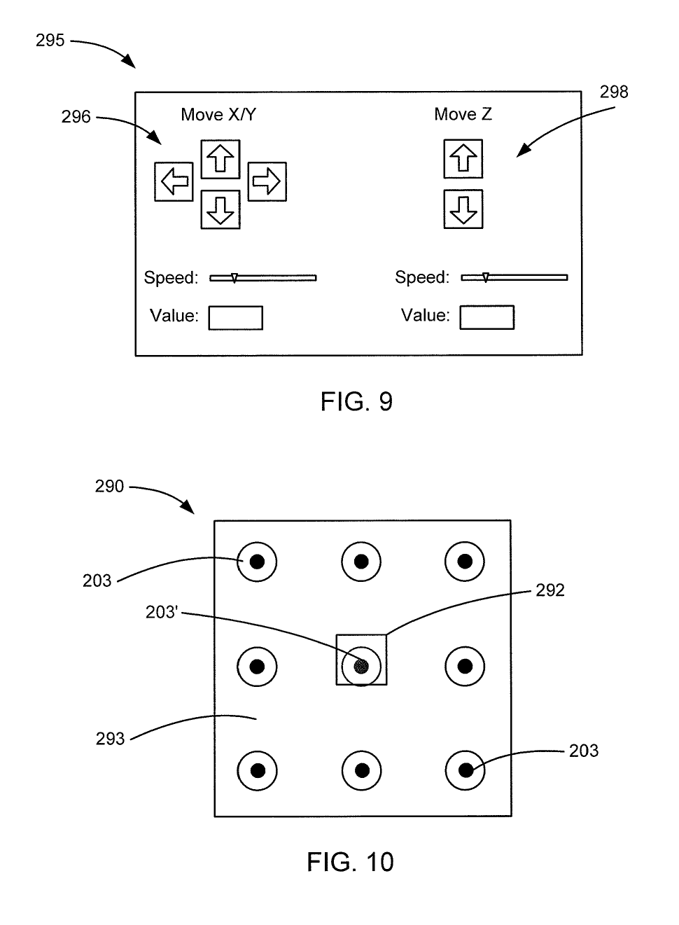

Using the control system 260, a user is able to control and/or move the head 204 of the liquid handler 200 to calibrate, initialize and/or zero the head 204 of the liquid handler 200. FIG. 9 is an illustration of a control interface 295 configured to be presented on the display 264, according to an embodiment. The control interface 295 includes X/Y controls 296 to control, cause and/or initiate movement of the head 204 along the X-axis and the Y-axis and Z controls 298 to control, cause and/or initiate movement of the head 204 along the Z-axis. In some embodiments, for example, a user is able to select and/or choose portions of the X/Y controls 296 and/or the Z controls 298 to cause and/or initiate movement of the head 204 with respect to the deck 210. The user can select and/or choose portions of the X/Y controls 296 and/or the Z controls 298 using a mouse, a touch screen, a keyboard, and/or the like. As shown in FIG. 9, the X/Y controls 296 also include a control to adjust, set and/or modify the speed at which the head 204 moves along the X-axis and the Y-axis. Similarly, the Z controls 296 also include a control to adjust, set and/or modify the speed at which the head 204 moves along the Z-axis.

FIG. 10 is an illustration of an X/Y calibration interface 290 configured to be presented on the display 264. The X/Y calibration interface 290 can be used to calibrate the head 204 with respect to the deck 210 along the X-axis and/or the Y-axis (i.e., in the X-dimension and the Y-dimension). The X/Y calibration interface 290 shows and/or displays an image of the bottom surface 293 of the head 204 produced and/or received by the imaging device 240. Accordingly, the X/Y calibration interface 290 shows at least a portion of the cones 203 coupled to the bottom surface 293 of the head 204. Additionally, the X/Y calibration interface 290 shows a calibration target 292 overlaid and/or superimposed on the image of the bottom surface 293 of the head 204 by the graphical use interface. To calibrate the head 204 with respect to the deck 210 along the X-axis and the Y-axis, the head 204 can be moved, using the X/Y controls 296, such that a predetermined (or calibration) cone 203′ is substantially aligned with the calibration target 292, as described in further detail herein. Similarly stated, the position of the head 204 with respect to the lens 241 of the imaging device 240 can be adjusted along the X-axis and the Y-axis using the control interface 295 such that the calibration cone 203′ is substantially aligned with the calibration target 292 on the graphical user interface.

In use, a user can calibrate, initialize and/or zero the head 204 with respect to the deck 210 using the calibration assembly 220 and the control system 260. The calibration assembly 220 is coupled to and/or placed at a predetermined position on the top surface 211 of the deck 210. As described above, the calibration assembly 220 is coupled to the top surface 211 such that movement of the calibration assembly 220 with respect to the deck 210 is limited. Similarly stated, the calibration assembly is coupled to and/or engages the top surface 211 such that its position with respect to the deck 210 is substantially fixed. In some embodiments, the predetermined position is at a specific deck plate 218. In other embodiments, the predetermined position is a position other than a deck plate.

After the calibration assembly 220 is coupled to and/or placed on the top surface 211, a user can position the head 204 with respect to the X-axis and the Y-axis such that the head 204 is positioned and/or disposed above the calibration assembly 220. Said another way, the user can position the head 204 such that the head 204 is substantially aligned with the calibration assembly 220 in the Z-dimension. The user can move and/or position the head using the X/Y controls 296 of the control interface 295 (FIG. 9). After the head 204 is positioned above the calibration assembly 220 (i.e., aligned with the calibration assembly 220 in the Z-dimension), the user can view the bottom surface 293 of the head 204 using the imaging device 240 (FIG. 10). While viewing the X/Y calibration interface 290, the user can use the X/Y controls 296 (FIG. 9) to move and/or position the head 204 such that the calibration cone 203′ is substantially aligned with the calibration target 292.

When the calibration cone 203′ is substantially aligned with the calibration target 292 (e.g., within the borders of the calibration target 292), the processor 262 of the control system 260 can set, define, initialize and/or store an X/Y calibration parameter in the memory 266. The X/Y calibration parameter indicates to the control system 260 the position along the X-axis and the Y-axis of the first predetermined position on the deck 204. Similarly stated, the X/Y calibration parameter is associated with a position and/or location of the first predetermined position in the X-dimension and the Y-dimension.

Using the X/Y calibration parameter, the processor 262 can calculate and/or determine the position and/or location of other predetermined positions relative to the deck 210 along the X-axis and the Y-axis. For example, the processor 262 can calculate and/or determine the location along the X-axis and the Y-axis of the deck plates 218 on the deck 210 using the X/Y calibration parameter and preprogrammed information about the locations of the deck plates 218 on the deck 210 with respect to the first predetermined position. Using the X/Y calibration parameter, the processor 262 can cause the motion mechanism 202 to automatically move the head 204 to a position along the X-axis and the Y-axis on the deck 210 of a given deck plate 218.

The user can calibrate, initialize and/or zero the head 204 with respect to the deck 204 along the Z-axis by moving and/or positioning the head 204 along the X-axis and/or the Y-axis, using the X/Y controls 296, such that the head 204 is disposed above the sensing tip 251 of the proximity sensor 251. Said another way, the user can use the X/Y controls 296 to move and/or position the head 204 such that the head 204 is aligned with the sensing tip 251 of the proximity sensor 250 in the Z-dimension. A user can then move the head 204 along the Z-axis toward the sensing tip 251 of the proximity sensor 250 using the Z controls 298. As the head 204 moves closer to the sensing tip 251, the cones 203 disposed on the bottom surface 293 of the head 204 approach to the sensing tip 251. Similarly stated, as the head 204 moves closer to the sensing tip 251, the distance between the cones 203 and the sensing tip 251 is reduced. When a cone 203 touches the sensing tip 251, an indication is sent to the user and/or a Z calibration parameter is set, defined, initialized and/or stored in the memory 266. The Z calibration parameter indicates to the control system 260 the position along the Z-axis (i.e., the height) of the second predetermined position on the deck 204. Similarly stated, the Z calibration parameter is associated with a position and/or location in the Z-dimension with respect to the deck 210 of the second predetermined position.

Using the Z calibration parameter, the processor 262 can calculate and/or determine the position and/or location of other predetermined positions relative to the deck 210 along the Z-axis. For example, based on the Z calibration parameter, the processor 262 can calculate and/or determine the height along the Z-axis of the deck plates 218 on the deck 210 and the height of any well plates 216 positioned at the deck plates 218. Using the Z calibration parameter and other preprogrammed information (e.g., the height of well plates at certain deck plates 218), the processor 262 can cause the motion mechanism 202 to automatically move the head 204 to the position of a deck plate 218 along the Z-axis on the deck 210 (i.e., the height of the deck plate 218). After the X/Y calibration parameter and the Z calibration parameter have been set, the head 204 is calibrated with respect to the deck 210 and can be used in the analysis and experimentation of liquids disposed within well plates 216 on the deck 210.

Although shown in FIG. 10 as being aligned with a calibration cone 203′, in other embodiments, any portion of the bottom surface 293 of the head 204 can be used as a reference marker to calibrate, initialize and/or zero the head 204 with respect to the deck 210 in the X-dimension and the Y-dimension. In some embodiments, for example, a predetermined (or calibration) pipette can be used. In such embodiments, the calibration pipette can be aligned with the calibration target 292 similar to the calibration cone 203′ shown and described with respect to FIG. 10. In other embodiments, a dimple, detent, crosshair, and/or marker on the bottom surface 293 of the head 204 can be used.

Similarly, while described above as being set when a cone 203 on the bottom surface 293 of the head 204 contacts and/or comes in close proximity to the sensing tip 251, in other embodiments, the Z calibration parameter can be set and/or stored when any portion of the head 204 contacts and/or comes in close proximity to the sensing tip 251. In some embodiments, for example, a calibration pipette can be used. In such embodiments, the Z calibration parameter can be set when the calibration pipette touches and/or comes in close proximity to the sensing tip 251. In other embodiments, any other portion of the head can be used.

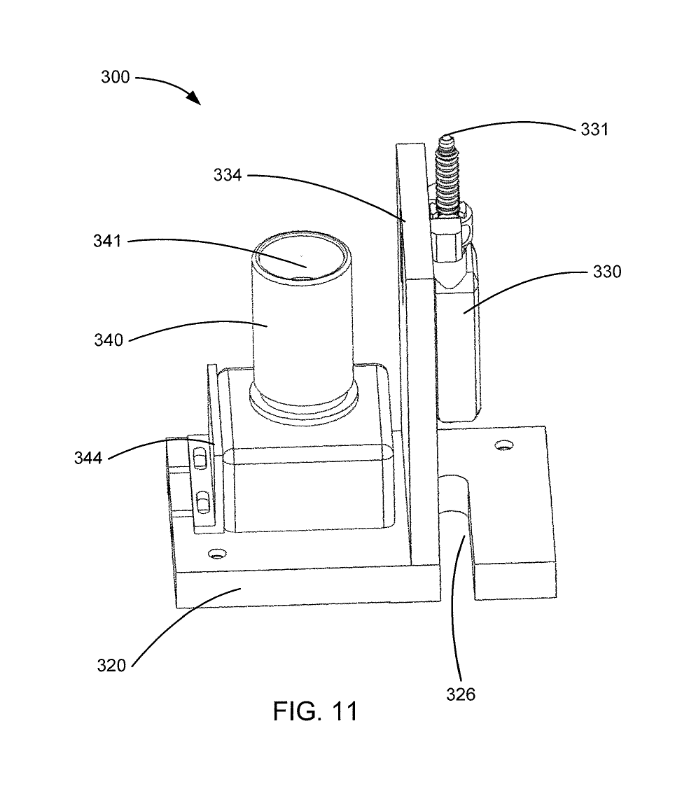

FIG. 11 illustrates a side perspective view of a calibration assembly 300, according to another embodiment. The calibration assembly 300 can be used to initialize, zero and/or calibrate a head of a liquid handler with respect to a deck, as described above with respect to FIGS. 1-10. The calibration assembly 300 includes a calibration member 320, an imaging device 340 and a proximity sensor 330. The imaging device 340 and the proximity sensor 330 can be structurally and functionally similar to the imaging device 240 and the proximity sensor 250, respectively, shown and described above with respect to FIGS. 6 and 7. As such, the imaging device 340 (including its lens 341) and the proximity sensor 330 (including its sensing tip 331) are not described in detail herein.

The calibration member 320 includes a first mounting portion 344, a second mounting portion 334 and defines a notch 326. Similar to the first mounting portion 244 of the calibration member 222 (FIG. 7), the first mounting portion 344 can be any connector configured to mount the imaging device 340 to the calibration member 300 such that movement of the imaging device 340 with respect to the calibration member 300 is limited. Similar to the second mounting portion 254 of the calibration member 222, the second mounting portion 334 can be any connector configured to mount the proximity sensor 330 to the calibration member 300 such that movement of the proximity sensor 330 with respect to the calibration member 300 is limited.

The notch 326 of the calibration member 320 is substantially aligned with the proximity sensor 330. Similarly stated, the notch 326 of the calibration member 320 is disposed beneath the proximity sensor 330. The notch 326 of the calibration member 320 is configured to accept a control connector (not shown in FIG. 11). For example, a cable operatively coupling the proximity sensor 330 to a control system can be at least partially disposed within the notch 326. Thus, if the control connector is operatively coupled to a bottom portion of the proximity sensor 330 (opposite the sensing tip 331) at a substantially right angle, the notch 326 can provide sufficient clearance, space and/or a sufficient gap between the bottom portion of the proximity sensor 330 and a deck (not shown in FIG. 11) on which the calibration assembly 300 is disposed, to easily couple the cable to the proximity sensor 330. Such a control connector can be structurally similar to the control connector 253, described above.

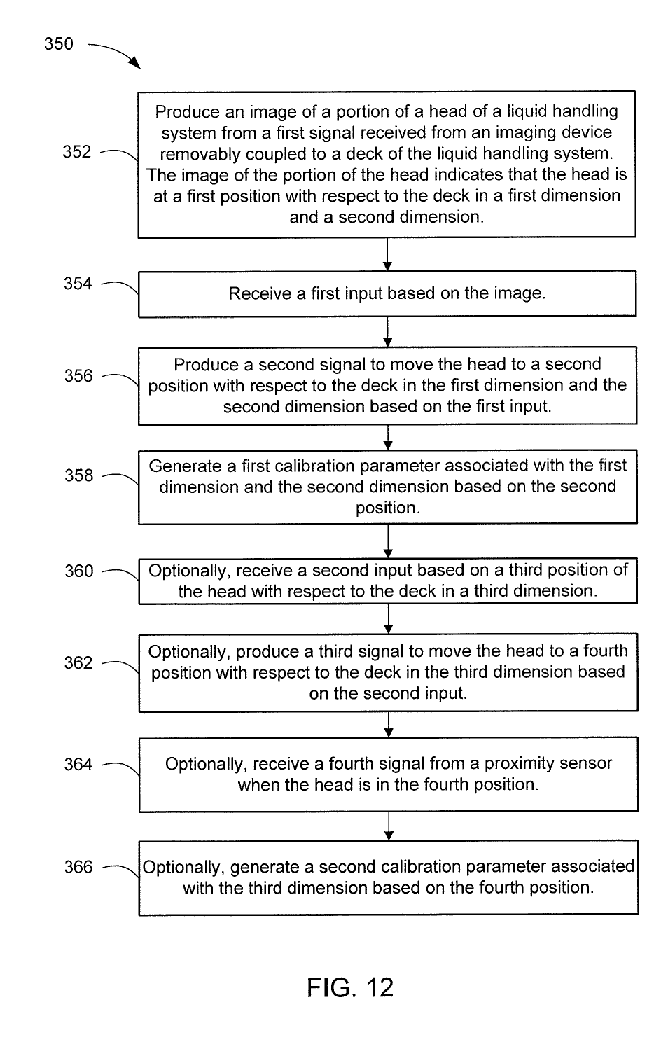

FIG. 12 is a flow chart illustrating a method 350 of calibrating a liquid handling system. The method 350 includes producing an image of a portion of a head of the liquid handling system from a first signal received from an imaging device removably coupled to a deck of the liquid handling system, at 352. The image of the portion of the head indicates that the head is at a first position with respect to the deck in a first dimension and a second dimension. In some embodiments, the imaging device can be part of a calibration assembly similar to the calibration assembly 120, the calibration assembly 220 and/or the calibration assembly 300 shown and described above.

A first input based on the image is received, at 354. The first input can be associated with an instruction to move the head with respect to the deck in the first dimension and/or the second dimension. In some embodiments, the first input can be provided and/or initiated by a user using an input device associated with a control system similar to the control system 260, shown and described above. In other embodiments, the first input can be automatically provided by a processor within a control system applying video analytics to the image, a sensor monitoring the position of the head and/or the like.

A second signal to move the head to a second position with respect to the deck in the first dimension and the second dimension is produced based on the first input, at 356. The second signal can be sent from a control system to the head of the liquid handler system. The second signal can be configured to move the head such that a calibration portion of the head is disposed at a predetermined position in the first dimension and the second dimension.

A first calibration parameter associated with the first dimension and the second dimension is generated based on the second position, at 358. Based on and/or using the first calibration parameter, the positions of other locations on the deck in the first dimension and the second dimension can be calculated. For example, the positions of various well plates on the deck in the first dimension and the second dimension can be calculated using the first calibration parameter and information about the other locations on the deck (e.g., the locations of the other locations on the deck with respect to the first calibration reference point). Accordingly, the head can move accurately and repeatably to the location of various well plates in the first dimension and the second dimension based on the first calibration parameter.

A second input based on a third position of the head with respect to the deck in a third dimension is optionally received, at 360. The second input can be associated with an instruction to move the head with respect to the deck in the third dimension. In some embodiments, the third input can be provided and/or initiated by a user using an input device associated with a control system similar to the control system 260, shown and described above. In other embodiments, the third input can be automatically provided by a processor within a control system applying video analytics to the image, a sensor monitoring the position of the head and/or the like.

A third signal to move the head to a fourth position with respect to the deck in the third dimension is optionally produced based on the second input, at 362. The third signal can be sent from the control system to the head of the liquid handler system. The third signal can be configured to move the head such that the calibration portion of the head is disposed at a predetermined position in the third dimension.

A fourth signal is optionally received from a proximity sensor when the head is in the fourth position, at 364. In some embodiments, the fourth signal can be generated by the proximity sensor when a portion of the head contacts the proximity sensor. In other embodiments, the fourth signal can be generated when a portion of the head is within a predetermined distance of the proximity sensor. In such embodiments, the proximity sensor can sense that the portion of the head is within the predetermined distance and send the fourth signal accordingly.

A second calibration parameter associated with the third dimension is optionally generated based on the fourth parameter, at 366. Based on the second calibration parameter, the positions of other locations on the deck in the third dimension can be calculated. For example, the positions of various well plates on the deck in the third dimension can be calculated using the second calibration parameter and information about the other locations on the deck. Similarly stated, based on the second calibration parameter, the height of various well plates placed on the deck can be calculated. This allows the head to accurately and repeatably move to the location of various well plates in the third dimension (e.g., height).

While a head of a liquid handling system is shown and described above as being manually moved and/or positioned (e.g., using the control interface 295 of FIG. 9) at a predetermined position with respect to a deck (e.g., aligned with a deck reference point in an X-dimension, a Y-dimension and/or a Z-dimension) by a user during calibration, in some embodiments, a head of a liquid handling system can be automatically moved and/or positioned into the predetermined position based on measurements and/or parameters automatically derived and/or produced by a calibration assembly and/or a control system. Specifically, as described in further detail herein, in some embodiments, the calibration assembly and/or a control system can determine a distance of the head from the predetermined position (e.g., the deck reference point) in the X-dimension, the Y-dimension and/or the Z-dimension (e.g., using a reference image, a diameter of a laser beam, a distance between two laser beams, video analytics, etc.). The distance of the head from the predetermined position can then be used by the liquid handling system to automatically move the head to the predetermined position. As described in further detail herein, such automatic alignment and/or calibration can reduce error by eliminating a mechanical sensor (e.g., proximity sensor 150) and can preserve the sterility of the head of the liquid handling system (e.g., by eliminating contact between the head and any part of the calibration assembly during calibration).

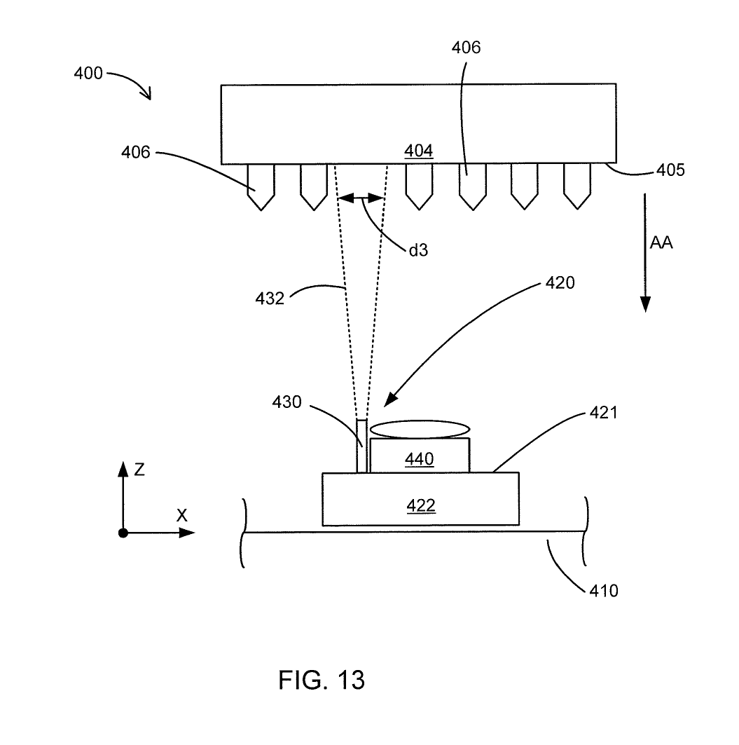

For example, FIG. 13 is a schematic illustration of a side view of a portion of a liquid handling system 400 and a calibration assembly 420 having a light source 430. The liquid handling system 400 is substantially similar to the liquid handling system 100 shown and described above with respect to FIGS. 1 and 2. Specifically, the liquid handling system 400 includes a deck 410 and a head 404 substantially similar to the deck 110 and the head 104, respectively. Accordingly, the head 404 includes a bottom surface 405 and can be removably coupled to a set of pipettes 406. In some embodiments, the head 404 includes a set of cones (not shown in FIG. 13) configured to removably couple the pipettes 406 to the bottom surface 405 of the head 404

The calibration assembly 420 is shown removably coupled to the deck 410 of the liquid handling system 400. The calibration assembly 420 includes a calibration member 422, an imaging device 440 and a light source 430. The calibration member 422 and the imaging device 440 are substantially similar to the calibration members and the imaging devices shown and described above, and are thus not described in detail herein.

The light source 430 can be any suitable light source that produces and/or emits one or more beams of light 432 that diverge at a known rate. The distance d3 illustrates a width and/or diameter of the beam of light 432 at an axial distance from the light source 430. In some embodiments, for example, the light source 430 can be a laser that emits a beam of light 432 that diverges (i.e., increases in area, width and/or diameter) a predetermined amount per axial distance from the light source 430. For example, the beam of light 432 can have a first width (e.g., 1 cm) at the light source 430 (i.e., at an axial distance or Z-dimension of zero). As the beam of light 432 is projected away from the light source 430, the width can increase at a known rate (e.g., 0.5 cm in width (X-dimension) for every 1 cm in the Z-dimension).

The light source 430 is coupled to the calibration member 422 and is positioned such that, when activated, the light source 430 projects a beam of light 432 in the Z-dimension. Similarly stated, the light source 430 projects a beam of light 432 in the direction of the bottom surface 405 of the head 404. As such, the light source 430 projects the beam of light 432 such that it is displayed on the bottom surface 405 of the head 404. As shown in FIG. 13, in some embodiments, the beam of light 432 is projected onto a portion of the bottom surface 405 of the head 404 without and/or devoid of a pipette 406 and/or cone. In other embodiments, the beam of light can be projected onto a portion of the bottom surface of the head having a pipette and/or cone.

The imaging device 440 is configured to monitor the beam of light 432 projected onto the bottom surface 405 of the head 404. More specifically, the imaging device 440 can periodically image (e.g., take and/or produce an image) the portion of the bottom surface 405 of the head 404 on which the beam of light 432 is projected.

In use, the head 404 of the liquid handling system 400 can be initialized, zeroed and/or calibrated with respect to the deck 410 using the calibration assembly 420. The calibration assembly 420 is disposed on the deck 410 such that the position of the calibration assembly 420 with respect to the deck 410 is substantially fixed in a predetermined position, as described above with respect to the calibration assemblies 120 and 220.

The head 404 of the liquid handling system 400 can be moved in the X-dimension and the Y-dimension such that the bottom surface 405 of the head 404 is disposed and/or positioned above the calibration assembly 420. The light source 430 can then be activated so a beam of light 432 is projected such that the light is displayed on the bottom surface 405 of the head 404. As shown in FIG. 13 and as described above, the light displayed on the bottom surface 405 of the head 404 can have a width, diameter and/or area.

The imaging device 440 can image the portion of the bottom surface 405 of the head 404 on which the beam of light 432 is projected. Using video analytics (e.g., edge detection techniques), a processor similar to processor 262 (not shown in FIG. 13) can determine and/or calculate the current width, diameter and/or area of the beam of light 432 projected onto the bottom surface 405 (using the image of the bottom surface 405 of the head 404). The processor can determine the distance between the calibration assembly 420 and the bottom surface 405 of the head 404 in the Z-dimension using the rate of divergence of the beam of light 432 and the calculated current width, diameter and/or area of the beam of light 432 on the bottom surface 405 of the head 404. Additionally, the processor can determine and/or calculate a distance (e.g., the number of motor steps) that the head 404 should move with respect to the calibration assembly 420 in the Z-dimension such that the head 404 is disposed a predetermined distance from the calibration assembly 420. Similarly stated, the processor can determine and/or calculate a distance that the head 404 should move with respect to the calibration assembly 420 in the Z-dimension such that the beam of light 432 projected on the bottom surface 405 of the head 404 has a predetermined width, diameter and/or area.

The processor can send a signal to a controller (not shown in FIG. 13) of the head 404 that causes the head 404 to move to the predetermined position with respect to the calibration assembly 420. After the head 404 is in the predetermined position, a calibration parameter associated with the Z-dimension can be set and/or stored in a memory. In some embodiments, prior to setting and/or storing the calibration parameter, the imaging device 440 can produce another image of the portion of the bottom surface 405 of the head 404 on which the beam of light 432 is projected such that the processor can verify that the head 404 is in the predetermined position (e.g., using video analytics to determine a width, diameter and/or area of the beam of light 432). In such embodiments, the processor can send one or more additional signals to move and/or adjust the position of the head 404 with respect to the calibration assembly accordingly. In other embodiments, moving the head 404 to the predetermined position can occur incrementally using multiple images. Such incremental movement can increase the accuracy of the calibration, decrease the time needed to complete calibration (e.g., by increasing the speed with which the head 404 moves in the Z-dimension) and/or the like.

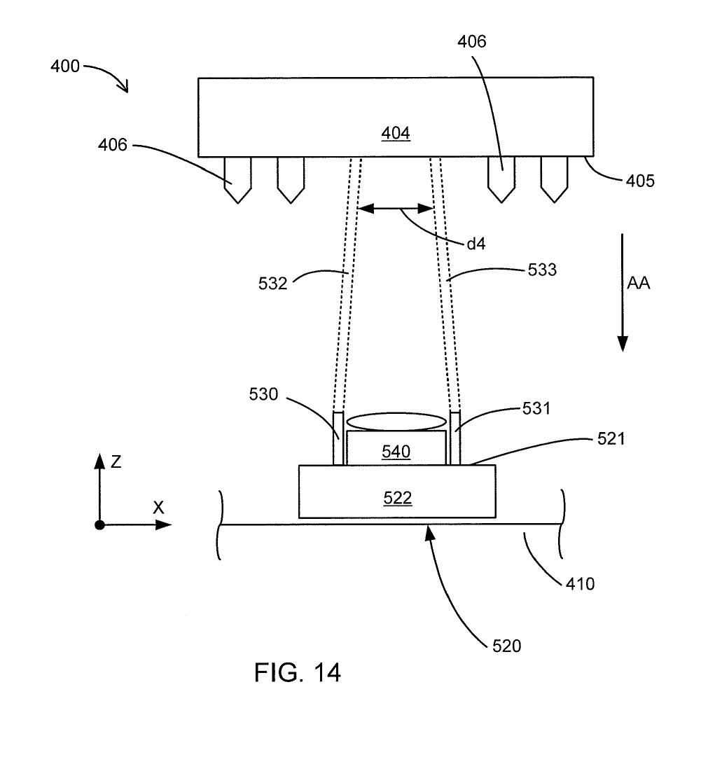

FIG. 14 is a schematic illustration of a side view of a portion of the liquid handling system 400 with a calibration assembly 520 including two light sources 530 and 531. The calibration assembly 520 is shown removably coupled to the deck 410 of the liquid handling system 400. The calibration assembly 520 includes a calibration member 522, an imaging device 540, a first light source 530 and a second light source 531. The calibration member 522 and the imaging device 540 are substantially similar to the calibration members and the imaging devices shown and described above, and are thus not described in detail herein.

The first light source 530 and the second light source 531 can be any suitable light sources that project a beam of light 532, 533, respectively, onto the bottom surface 405 of the head 404. In some embodiments, for example, the light sources 530, 531 can be collimated lasers that produce beams 532, 533 that do not significantly diverge. In other embodiments, the light sources 530, 531 can be lasers that produce light beams having a known rate of divergence.

As shown in FIG. 14, each light source 530, 531 can be configured to produce a beam of light 532, 533 angled toward the other beam of light 532, 533. Similarly stated, each light source 530, 531 is configured and/or coupled to the calibration member 522 such that a longitudinal axis defined by the first beam of light 532 intersects a longitudinal axis defined by the second beam of light 533. As such, a distance d4 in the X-dimension between the first beam of light 532 and the second beam of light 533 decreases the further away from the calibration assembly 520 (in the Z-dimension) the measurement of the distance d4 is taken (until the beams of light 532, 533 cross). The rate of change of the distance d4 between the first beam of light 532 and the second beam of light 533 with respect to the distance from the calibration assembly 520 in the Z-dimension can be predetermined and/or precalculated. For example, the distance d4 between the first beam of light 532 and the second beam of light 533 can vary at a rate of 0.5 cm (in the X-dimension) per every 1 cm the head 404 is moved from the calibration assembly in the Z-dimension. Accordingly, the distance between the calibration assembly 520 and the bottom surface 405 of the head 404 can be calculated using the rate of change and the distance d4 between the first beam of light 532 and the second beam of light 533 projected on the bottom surface 405 of the head 404.

In use, the head 404 of the liquid handling system 400 can be initialized, zeroed and/or calibrated with respect to the deck 410 using the calibration assembly 520. Similar to the calibration procedures using the calibration assembly 420, the calibration assembly 520 is disposed on the deck 410 such that the position of the calibration assembly 520 with respect to the deck 410 is substantially fixed in a predetermined position.

The head 404 of the liquid handling system 400 can be moved in the X-dimension and the Y-dimension such that the bottom surface 405 of the head 404 is disposed and/or positioned above the calibration assembly 520. The first light source 530 and the second light source 531 can be activated to project a first beam of light 532 and a second beam of light 533 onto the bottom surface 405 of the head 404. As shown in FIG. 14, a distance d4 exists between the first beam of light 532 and the second beam of light 533.

The imaging device 540 can produce an image of the portion of the bottom surface 405 of the head 404 on which the first beam of light 532 and the second beam of light 533 are projected. Using video analytics, a processor (using the image of the bottom surface 405 of the head 404) can determine and/or calculate the current distance d4 between the first beam of light 532 and the second beam of light 533 (in the X-dimension) projected on the bottom surface 405 of the head 404. The processor can determine the distance between the calibration assembly 520 and the bottom surface 405 of the head 404 in the Z-dimension based on the known rate of change of the distance between the first beam of light 532 and the second beam of light 533 and the measured distance d4 between the first beam of light 532 and the second beam of light 533 projected on the bottom surface 405 of the head 406.

Additionally, the processor can determine and/or calculate a distance (e.g., the number of motor steps in the Z-dimension) that the head 404 should move with respect to the calibration assembly 520 in the Z-dimension such that the head 404 is disposed a predetermined distance from the calibration assembly 520. Similarly stated, the processor can determine and/or calculate a distance that the head 404 should move with respect to the calibration assembly 520 in the Z-dimension such that the distance d4 between the first beam of light 532 and the second beam of light 533 projected on the bottom surface 405 of the head 404 is a predetermined distance. The processor can then send a signal to a controller of the head 404 that causes the head 404 to move to the predetermined position with respect to the calibration assembly 420. After the head is in the predetermined position, a calibration parameter associated with the Z-dimension can be set and/or stored in a memory. In other embodiments, movement of the head in the Z-dimension (e.g., to the predetermined position) can be incremental using multiple images.

In other embodiments, an imaging device can use a focusing system to calibrate the head of the liquid handling system in the Z-dimension. In such embodiments, for example, the imaging device can focus on a pipette, cone and/or other predetermined portion of the bottom surface of the head disposed above the imaging device (i.e., aligned with the imaging device in the Z-dimension). Similarly stated, the imaging device can focus such that the focal point of the lens of the imaging device is at the pipette, cone and/or other predetermined portion of the bottom surface of the head. A processor can determine the distance between the calibration assembly and the head (e.g., the focal point) in the Z-dimension based on the predetermined distance to the focal point of the lens from the lens. In some embodiments, the imaging device includes a rangefinder. Such an imaging device allows the imaging device to more accurately focus and determine the distance between the calibration assembly and the head in the Z-dimension.

While automatic alignment and/or calibration of a head of a liquid handling system in the Z-dimension is shown and described with respect to FIGS. 13 and 14, in other embodiments, the head of the liquid handling system can also be automatically aligned and/or calibrated in the X-dimension and/or the Y-dimension. In some embodiments, for example, an imaging device of a calibration assembly can produce a reference image of a predetermined portion of the bottom surface of the head (e.g., a predetermined marked pipette, cone and/or other portion) in a predetermined position with respect to the calibration assembly in the X-dimension and the Y-dimension. Such a reference image can be stored in a memory to be used in future calibrations of the head with respect to the calibration assembly in the X-dimension and the Y-dimension. In some embodiments, an imaging device used to automatically align and/or calibrate the head can include integral illumination that ensures that the illumination and/or contrast associated with the images produced by the imaging device and analyzed by a processor is substantially consistent over time.

Using the reference image, the head of the liquid handling system can be calibrated in the X-dimension and the Y-dimension. For example, a current image of the bottom surface of the head can be produced by the imaging device. A processor can then compare the current image with the reference image. More specifically, a processor can determine the position of the predetermined portion of the bottom surface of the head within the image frame of the current image (e.g., in pixel coordinates) and compare that to the position of the predetermined portion of the bottom surface of the head within the image frame of the reference image. Using the difference in pixel coordinates in the X-dimension and the Y-dimension (e.g., converted into motor steps, distance and/or another suitable value), the processor can send a signal to move the head such that the predetermined portion of the bottom surface of the head is moved to the same position as the predetermined portion of the bottom surface of the head in the reference image. As discussed above, a calibration parameter in the X-dimension and Y-dimension can then be set and/or stored in a memory.

In other embodiments, instead of using a reference image, the processor can store a reference pixel coordinate value of the predetermined portion of the bottom surface of the head of the reference image (e.g., an X-coordinate and a Y-coordinate) in a memory. Such a pixel coordinate value can be used to calibrate the head. For example, a pixel coordinate value of the predetermined portion of the bottom surface of the head in a current position can be calculated and/or derived from a current image. The processor can send a signal to move the head such that the predetermined portion of the bottom surface of the head is moved to the reference pixel coordinates. Accordingly, the calibration assembly can calibrate and/or align the head based on the difference in pixel coordinates between the reference pixel coordinate value and the current pixel coordinate value.

While various embodiments have been described above, it should be understood that they have been presented by way of example only, and not limitation. Where methods and/or schematic illustrations described above indicate certain events and/or flow patterns occurring in certain order, the ordering of certain events and/or flow patterns may be modified. While the embodiments have been particularly shown and described, it will be understood that various changes in form and details may be made.

While embodiments described herein are described using a three-dimensional Cartesian coordinate system, in other embodiments, any coordinate system can be used. In some embodiments, for example, a curvilinear coordinate system, and/or a polar coordinate system (e.g., circular, cylindrical, spherical) can be used to describe the relationships between the deck, head and calibration system.

While described in FIGS. 1 and 2 as being substantially fixed with respect to the calibration member 122, in other embodiments, the imaging device 140 and/or the proximity sensor 150 can move with respect to the calibration member 122 in one or more dimensions. For example, in some embodiments, the imaging device 140 can move with respect to the calibration member 122 in the Z-dimension to focus on a portion of the head 104.

Some embodiments described herein relate to a computer storage product with a computer- or processor-readable medium having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as general purpose microprocessors, microcontrollers, Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

Although various embodiments have been described as having particular features and/or combinations of components, other embodiments are possible having a combination of any features and/or components from any of the embodiments as discussed above. For example, in some embodiments, a deck of a liquid handling system can include any number of deck plates and/or predetermined positions at which a well plate can be placed. For another example, the calibration methods and/or procedures described herein with respect to calibration assembly 220 can include the automatic movement and/or positioning procedures shown and described above with respect to calibration assembly 420 and/or calibration assembly 520.

What is claimed is:

1. An apparatus, comprising:
a calibration member configured to be removably coupled to a deck of a liquid handling system, the calibration member having an alignment portion configured to matingly engage a portion of the deck such that a position of the calibration member is fixed with respect to the deck;
an imaging device coupled to the calibration member such that an axis of a lens of the imaging device intersects the deck at a first predetermined location relative to a deck reference point in at least a first dimension and a second dimension; and
a proximity sensor coupled to the calibration member such that a calibration reference point on the proximity sensor is at a second predetermined location relative to the deck reference point in a third dimension.

2. The apparatus of claim 1, wherein the calibration reference point is at the second predetermined location relative to the deck reference point in the first dimension and the second dimension.

3. The apparatus of claim 1, wherein the calibration reference point is a first calibration reference point, the axis of the lens intersecting a second calibration reference point on the calibration member in at least the first dimension and the second dimension when the calibration member is coupled to the deck.

4. The apparatus of claim 1, wherein the alignment portion is configured to be matingly received within a recess defined by the deck.

5. The apparatus of claim 1, wherein the imaging device is coupled to the calibration member such that the axis of the lens of the imaging device is substantially normal to a surface of the deck.

6. The apparatus of claim 1, wherein the proximity sensor is configured to produce an electronic output when a portion of a head of the liquid handling system contacts the proximity sensor.

7. The apparatus of claim 1, wherein the imaging device includes a charge coupled device configured to produce an electronic output associated with a portion of a head of the liquid handling system.

8. The apparatus of claim 1, wherein the calibration reference point is a first calibration reference point, a second calibration point on the calibration member being at a third predetermined position relative to the deck reference point in at least the first dimension and the second dimension when the calibration member is coupled to the deck.

9. A system, comprising:
a calibration assembly configured to be removably coupled to a deck of a liquid handling system such that an alignment portion of the calibration assembly matingly engages a portion of the deck of the liquid handling system, the calibration assembly including an imaging device and a proximity sensor, the imaging device configured to produce a first electronic output associated with a first position of a portion of a head of the liquid handling system relative to the deck in a first dimension and a second dimension, the proximity sensor configured to produce a second electronic output associated with a second position of the portion of the head relative to the deck in a third dimension; and
a control system configured to produce a calibration parameter based, at least in part, on the first electronic output and the second electronic output, the control system configured to move the portion of the head relative to the deck in the first dimension, the second dimension and the third dimension to at least a third predetermined position based, at least in part, on the calibration parameter.

10. The system of claim 9, wherein the alignment portion of the calibration assembly is configured to matingly engage the portion of the deck such that an axis of a lens of the imaging device intersects the deck at a first predetermined position relative to a deck reference point in at least the first dimension and the second dimension, and a calibration reference point on the proximity sensor is at a second predetermined position relative to the deck reference point in the third dimension.

11. The system of claim 9, wherein:
the deck defines a recess configured to matingly receive at least a portion of a well plate; and
the alignment portion is configured to be matingly received within the recess of the deck.

12. The apparatus of claim 9, wherein the alignment portion of the calibration assembly is configured to matingly engage the portion of the deck such that an axis of a lens of the imaging device is substantially normal to a surface of the deck.

13. The apparatus of claim 9, wherein the proximity sensor is configured to produce the second electronic output when the portion of the head contacts the proximity sensor.

14. The apparatus of claim 9, wherein the first electronic output is configured to display an image of the portion of the head on a display.

15. A method, comprising:
producing an image of a portion of a head of a liquid handling system from a signal received from an imaging device removably coupled to a deck of the liquid handling system, the image of the portion of the head indicating that the head is at a first position with respect to the deck in a first dimension and a second dimension;
receiving an input based on the image;
producing a signal to move the head of the liquid handling system to a second position with respect to the deck in the first dimension and the second dimension based on the input; and
generating a calibration parameter associated with the first dimension and the second dimension based on the second position.

16. The method of claim 15, wherein the input is a first input and the calibration parameter is a first calibration parameter, the method further comprising:
receiving a second input based on a third position of the head with respect to the deck in a third dimension;
producing a signal to move the head of the liquid handling system to a fourth position with respect to the deck in the third dimension based on the second input;
receiving a signal from a proximity sensor when the head of the liquid handling system is in the fourth position; and
generating a second calibration parameter associated with the third dimension based on the fourth position.

17. The method of claim 15, further comprising:
moving the head relative to the deck in the first dimension and the second dimension to a predetermined position based, at least in part, on the calibration parameter.

18. The method of claim 15, wherein the imaging device is removably coupled to the deck such that an axis of a lens of the imaging device intersects the deck at a predetermined position relative to a deck reference point in at least the first dimension and the second dimension.

19. The method of claim 15, wherein the imaging device is coupled to a calibration assembly having an alignment portion configured to matingly engage a predetermined portion of the deck.

20. The method of claim 15, wherein the imaging device is coupled to a calibration assembly such that an axis of a lens of the imaging device is substantially normal to a surface of the deck.
